(19) United States
(12) Patent Application Publication
(10) Pub. No.: US 2024/0303999 A1
(43) Pub. Date: Sep. 12, 2024

(54) DYNAMIC MEC-ASSISTED TECHNOLOGY AGNOSTIC COMMUNICATION

(71) Applicant: FORD GLOBAL TECHNOLOGIES, LLC, Dearborn, MI (US)

(72) Inventors: Somak DATTA GUPTA, Novi, MI (US); Arpita CHAND, Dearborn, MI (US)

(21) Appl. No.: 18/181,017

(22) Filed: Mar. 9, 2023

(51) Int. Cl. G06V 20/58; G08G 1/01

(52) U.S. Cl. CPC G06V 20/58; G08G 1/0116

(57) ABSTRACT

A FODM for multi-radio access technology (RAT) vehicle-to-everything (V2X) communication is provided. One or more hardware components are configured to receive connected messages from vehicles, the connected messages specifying vehicle information including vehicle locations of the vehicles; receive perception objects from sensors of roadside infrastructure, the perception objects specifying object locations as perceived by the sensors; utilize a fusion component to combine the vehicle locations and the object locations to form a consolidated object database including data elements specifying each of the vehicles and the perception objects; utilize a sensor data sharing message (SDSM) generator to generate SDSMs describing each of the data elements of the consolidated object database; and utilize a message broker to publish the SDSMs to topics for retrieval by the vehicles.

### TECHNICAL FIELD

Aspects of the present disclosure generally relate to dynamic multi-access edge computing (MEC) assisted technology agnostic communication.

### BACKGROUND

Cellular vehicle-to-everything (C-V2X) allows vehicles to exchange information with other vehicles, as well as with infrastructure, pedestrians, networks, and other devices. Vehicle-to-infrastructure (V2I) communication enables applications to facilitate and speed up communication or transactions between vehicles and infrastructure. In a vehicle telematics system, a telematics control unit (TCU) may be used for various remote-control services, such as over the air (OTA) software download, eCall, and turn-by-turn navigation.

### SUMMARY

In one or more illustrative examples, a federated object data mechanism (FODM) for multi-radio access technology (RAT) vehicle-to-everything (V2X) communication includes one or more hardware components. The one or more hardware components are configured to receive connected messages from vehicles, the connected messages specifying vehicle information including locations of the vehicles; receive perception objects from sensors of roadside infrastructure, the perception objects specifying object locations as perceived by the sensors; utilize a fusion component to combine the vehicle locations and the object locations to form a consolidated object database including data elements specifying each of the vehicles and the perception objects; utilize a sensor data sharing message (SDSM) generator to generate SDSMs describing each of the data elements of the consolidated object database; and utilize a message broker to publish the SDSMs to topics for retrieval by the vehicles.

In one or more illustrative examples, a method for providing a FODM for RAT V2X communication using one or more hardware components includes receiving connected messages from vehicles, the connected messages specifying vehicle information including vehicle locations of the vehicles; receiving perception objects from sensors of roadside infrastructure, the perception objects specifying object locations as perceived by the sensors; utilizing a fusion component to combine the vehicle locations and the object locations to form a consolidated object database including data elements specifying each of the vehicles and the perception objects; utilizing a SDSM generator to generate SDSMs describing each of the data elements of the consolidated object database; and utilizing a message broker to publish the SDSMs to topics for retrieval by the vehicles.

In one or more illustrative examples, a non-transitory computer-readable medium includes instructions for providing a FODM for RAT V2X communication that, when executed by one or more hardware components, cause the one or more hardware components to perform operations including to receive connected messages from vehicles, the connected messages specifying vehicle information including vehicle locations of the vehicles; receive perception objects from sensors of roadside infrastructure, the perception objects specifying object locations as perceived by the sensors; utilize a fusion component to combine the vehicle locations and the object locations to form a consolidated object database including data elements specifying each of the vehicles and the perception objects; utilize a SDSM generator to generate SDSMs describing each of the data elements of the consolidated object database; and utilize a message broker to publish the SDSMs to topics for retrieval by the vehicles.

### BRIEF DESCRIPTION OF THE DRAWINGS

FIG. 1 illustrates an example system for interoperability of vehicles having different communications technologies;

FIG. 2 illustrates a consolidated functional diagram and topology of the logical interconnect plane;

FIG. 3A illustrates a functional diagram and topology of the logical interconnect plane in an RSU-based mode;

FIG. 3B illustrates a functional diagram and topology of the logical interconnect plane in a cloud-based mode;

FIG. 3C illustrates a functional diagram and topology of the logical interconnect plane in a MEC-based mode;

FIG. 4A illustrates an example of far edge data fusion at the roadside using the logical interconnect plane operating in the RSU-based mode of FIG. 3A;

FIG. 4B illustrates an example of baseline data fusion at the cloud component using the logical interconnect plane operating in the cloud-based mode of FIG. 3B;

FIG. 4C illustrates an example of MEC-based data fusion at the cloud component using the logical interconnect plane operating in the MEC-based mode of FIG. 3C;

FIG. 5A illustrates an example data flow diagram of the far edge data fusion at the roadside using the logical interconnect plane operating in the RSU-based mode of FIG. 3A;

FIG. 5B illustrates an example data flow diagram of the cloud-based data fusion at the cloud component using the logical interconnect plane operating in the cloud-based mode of FIG. 3B;

FIG. 5C illustrates an example data flow diagram of the MEC-based data fusion at the MEC using the logical interconnect plane operating in the MEC-based mode of FIG. 3C;

FIG. 6 illustrates an example network diagram of elements of the logical interconnect plane configured for operation in the MEC-based mode;

FIG. 7 illustrates details of the operation of a centralized fusion to provide a FODM to client devices;

FIG. 8A illustrates an example implementation of the centralized fusion in an RSU-based mode;

FIG. 8B illustrates an example implementation of the centralized fusion in a MEC-based mode;

FIG. 8C illustrates an example implementation of the centralized fusion in a cloud-based mode;

FIG. 9 illustrates an example data flow diagram for use of the centralized fusion of the logical interconnect plane in the edge-based mode for object notification;

FIG. 10 illustrates an example process for implementing centralized fusion via the logical interconnect plane for seamless communication; and

FIG. 11 illustrates an example of a computing device for use in interoperability of vehicles having different communications technologies.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications.

There has been a proliferation of connected vehicles in the recent times. Most new vehicles are equipped with one or more forms of communication technologies, such as a TCU, C-V2X radio services, etc. Other more advanced communication technologies may also be deployed in the vehicles. Currently, to perform local vehicle-to-vehicle (V2V) communication, the vehicles may either have C-V2X or dedicated short range communication (DSRC) connectivity. As these technologies differ in the physical layer, the two technologies may be unable to communicate with one other.

Vehicles with different communication technologies may work in silos, unable to exchange contextual information with each other. Legacy vehicles may be unable to advertise their presence to other connected vehicles, and vehicles with different communication technologies may be unable to directly broadcast or otherwise communicate information to other vehicles that lack support for the same communication technologies. These types of technical differences in the communication technologies make it impossible for all the connected vehicles to interoperate. This inability to interoperate dilutes the benefit of V2X applications.

An edge computing-based solution may be used to overcome this technology fragmentation. Yet, a challenge with edge-based solutions is allocation of resource for the edge-based applications. Any statically architected solution may face drawbacks such as scaling limitations and unoptimized resource allocation.

A scaling solution for edge-based applications may be configured to address resource allocation. The solution provides a seamless approach to allowing vehicles equipped with disparate communication technologies communicate with each other through the edge-based approach, while being cognizant of application requirements such as latency, throughput, quality of service (QOS), security, etc. The edge may disseminate relevant information (e.g., application data, alerts, available services around the vehicle, etc.) to subscribed users using different communication technologies, (e.g., cellular Uu, PC5, etc.). This introduces welcome redundancy into the system, which makes the system more robust and ensures the subscribed vehicles are less prone to missing out relevant information. The solution may also extend to the dynamic resource management of the edge applications hosted in the edge or cloud or point of presence (POP), through vehicle trajectory and destination modulated intelligent resource scaling. The edge-based solution may make it possible for disparate types of connected vehicles, using different non-interoperable communication technologies, to seamlessly communicate with each other.

A federated object data mechanism (FODM) for RAT V2X communication may be implemented using the architecture. This service may collect information using BSM packets from the vehicular network and perception information from infrastructure-based sensors. The service may fuse the collected data, offering the communication participants with a consolidated, deduplicated, and accurate object database. Since fusing the objects is resource intensive, this service can save in-vehicle computation resources. The combination of diverse input sources may enhances the object detection accuracy, which can benefit vehicle advanced driver assistance system (ADAS) or autonomous driving functions.

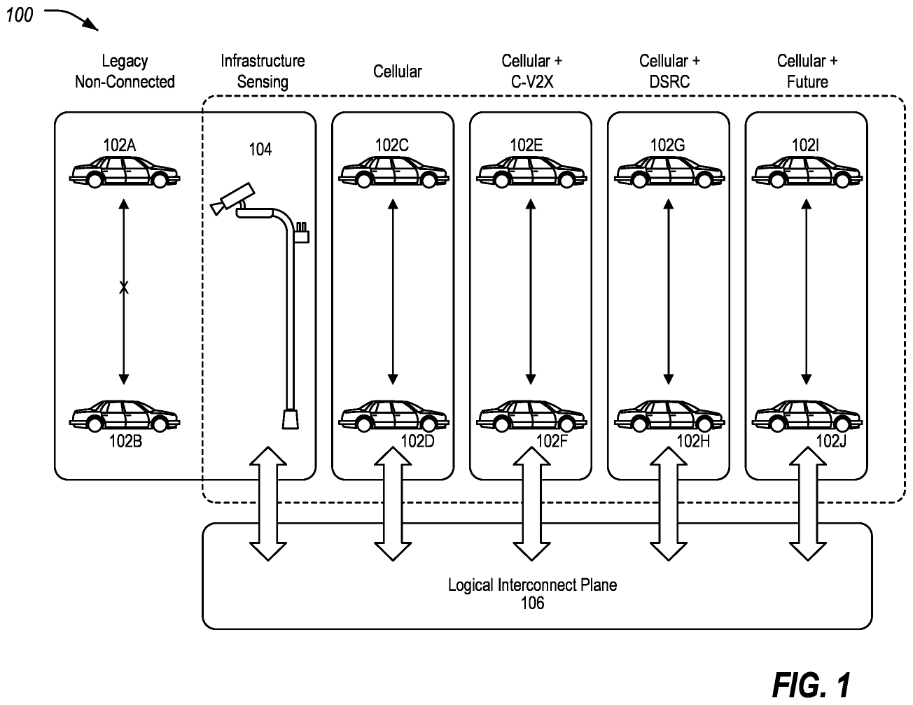

FIG. 1 illustrates an example system 100 for interoperability of vehicles 102 having different communications technologies. As shown, the system 100 includes non-connected legacy vehicles 102A-102B that lack on-board units (OBU). Although these vehicles 102A-102B may be unable to communicate (even with one another), they may be able to be sensed by infrastructure 104 such as cameras or other roadside sensors). The system 100 also shows cellular vehicles 102C-102D which may include TCUs configured to communicate cellularly with one another. The system 100 further shows cellular and C-V2X vehicles 102E-102F which may include TCUs configured to communicate cellularly and via C-V2X with one another. The system 100 also shows cellular and DSRC vehicles 102G-102H which may include TCUs configured to communicate cellularly and via DSRC with one another. The system 100 also shows hypothetical cellular and future technology vehicles 1021-102J which may include TCUs configured to communicate cellularly and via new technologies that may become available.

A logical interconnect plane 106 may be implemented to facilitate communication between these (and other) different non-interoperable communication technologies. The logical interconnect plane 106 may utilize MEC nodes and other infrastructure 104 to alleviate the communication gap between these incompatible technologies. The MEC nodes may bring cloud capabilities closer to the end user, and in this case, as an external node deployed in a mobile network operator (MNO) base station, which may provide relatively lower latency and higher bandwidth compared to cloud-based solutions.

The logical interconnect plane 106 may connect to the vehicles 102 via cellular Uu connection through the respective TCUs of the vehicles 102. Such a communication mechanism, enabled through use of the MECs may provide service to not only its current serving cell, but even neighboring cell sites, saving on infrastructure 104. A vehicle 102 subscribed to that MNO, may leverage the benefits of the MEC. The logical interconnect plane 106 may operate across MNOs, e.g., if the individual MNOs have subscribed to a service presence-based routing support.

The logical interconnect plane 106 may also provide a configurable mechanism to dynamically geofence the region of interest relevant to each participating vehicles 102 on a per application basis. The MEC may host various services, such as streaming or contextual based services and may cater to a particular geographical area. A vehicle 102 equipped with a TCU, responsive to its entrance into the geographical location, may publish contextual information to the appropriate MEC service. Other vehicles 102 subscribed to the service in the vicinity may receive this relevant information. Thus, the MEC may aid in service discovery when vehicles 102 enter a specific geofenced location.

In an example, the vehicle 102E and the vehicle 102C may be subscribed to contextual awareness service in the MEC. The vehicle 102E may receive broadcasted information that a vehicle 102 that has met with an obstruction ahead via its PC5 interface. The vehicle 102E publishes this information via its cellular Uu interface to the MEC. The MEC then distributes this information to vehicle 102C (and all the other pertinent vehicles 102 subscribed to the same service), making them aware of their surroundings, despite having a disparate communication radio.

In the case of a legacy, non-connected vehicle 1021-B (e.g., without a TCU), if a smart infrastructure 104 sensor is present, such as a camera/radar, the infrastructure 104 may detect the presence of the legacy vehicle 102A-102B and send this information to the MEC. The MEC may then take steps to advertise its presence to neighboring connected vehicles 102C-102J, which may use this information as an input to their connected applications.

The logical interconnect plane 106 may accordingly provide a global solution for seamless communication across inherently non-interoperable communication technologies through a common communication conduit. The edge-based approach of the logical interconnect plane 106 may cater to larger number of vehicles 102 in a greater geographic area than a local solution such as road side units (RSUs).

While a MEC may dynamically tune its computational parameters, to address varying workloads, the logical interconnect plane 106 may utilize vehicle 102 trajectories and destinations to scale resource footprints of the edge applications. For example, participating vehicles 102 may be tracked to generate accurate resource needs and dynamically perform resource scaling.

While traditionally V2X communication is standardized by predefined OTA messages from society of automotive engineer (SAE) specifications, the logical interconnect plane 106 may also support future communication paradigms such as named data networks and non-rigid, evolving and secure communication mechanisms through a stateful mechanism of information exchange, which reduces information and process redundancy. Additionally, end-to-end latency of a MEC-based approach is more performant than a cloud-based approach. Thus allows the logical interconnect plane 106 to better meet the latency requirements of connected applications.

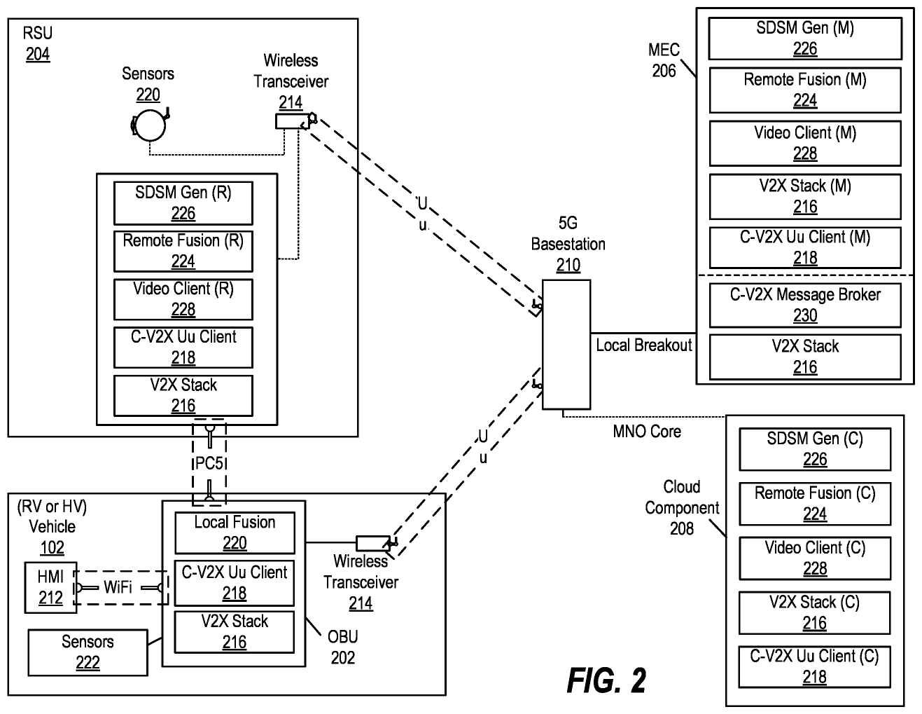

FIG. 2 illustrates a consolidated functional diagram 200 and topology of the logical interconnect plane 106. As shown in the consolidated functional diagram 200, one or more OBUs 202 (e.g., of the vehicles 102), RSUs 204, MECs 206, and cloud components 208 may be in communication with one another. The OBUs 202 and the RSUs 204 may be configured to communicate with one another without requiring the services of a cellular network, over protocols such as PC5. The OBUs 202 and the RSUs 204 may also be in communication with the cellular network via various base stations 210, e.g., via a Uu protocol in the illustrated example.

The cloud component 208 may be in communication with the base station 210 over the MNO core. The MNO core is the central network infrastructure that provides connectivity to mobile devices such as cellular phones. The MNO Core may include components such as switches, routers, and servers that enable such communication over large areas. In V2X communication systems, the MNO Core can be used to provide Internet connectivity to the vehicles 102 and infrastructure components, enabling the transmission of V2X messages over the cellular network.

The base station 210 may also be in communication with one or more MECs 206 via a local breakout connection. Local breakout is a feature of 5G networks that enables traffic to be routed directly to the Internet from the base station 210, without passing through the MNO Core. This may reduce latency and increase the efficiency of data transfer in certain use cases, such as V2X communication. Local breakout may be used to provide faster connectivity the vehicles 102 and the MEC 206 as compared to the speed between the vehicles 102 and the cloud components 208, enabling faster and more efficient V2X communication and edge processing.

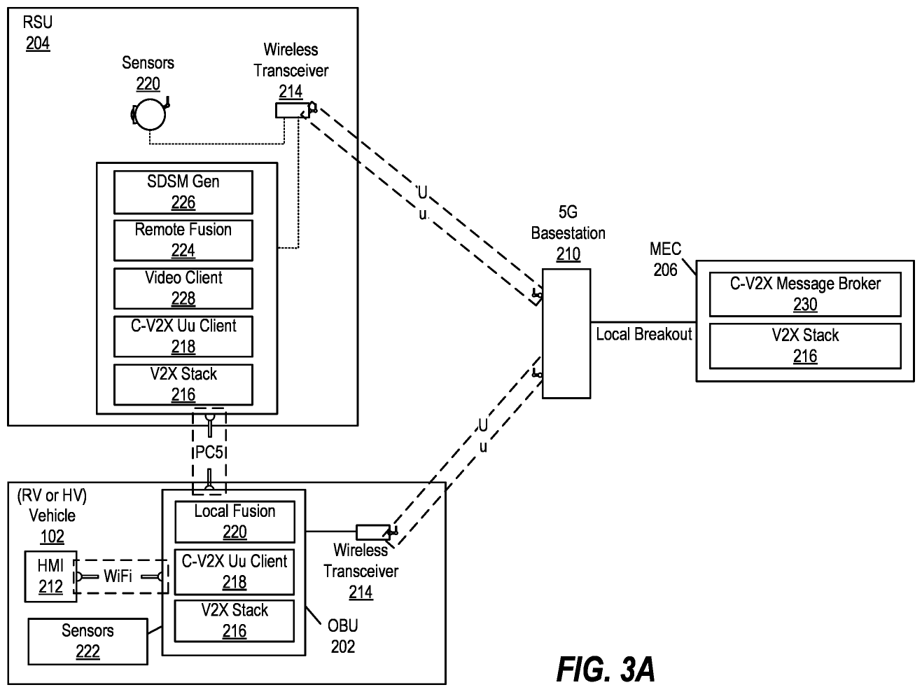

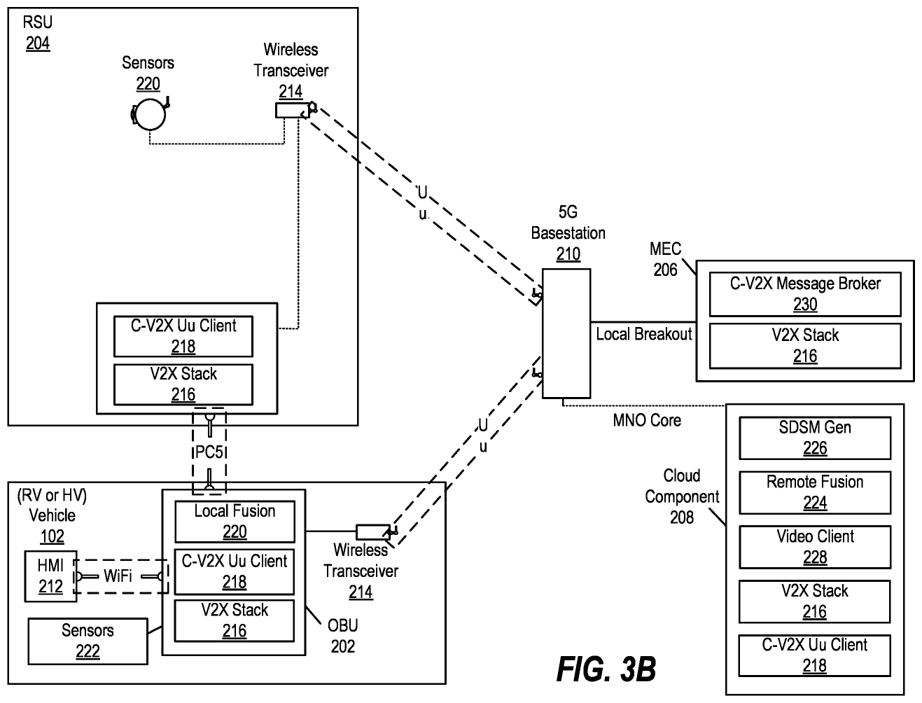

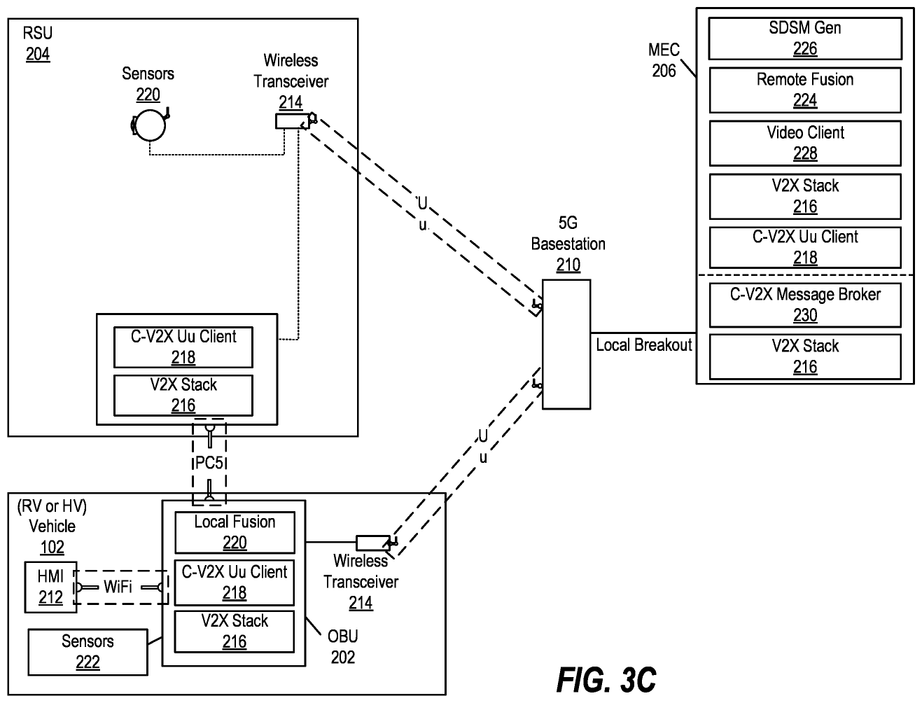

These components of the consolidated functional diagram 200 may support various different modes of operation. These modes may include an RSU-based mode (as shown in FIG. 3A) a cloud-based mode (as shown in FIG. 3B), and a MEC-based mode (as shown in FIG. 3C).

Referring back to FIG. 2, the components that are utilized only in the cloud-based mode are specified in the consolidated functional diagram 200 with the (C) suffix. The components that are utilized only in the MEC-based mode are specified with the (M) suffix. The components that are utilized only in the RSU-based mode are specified with the (R) suffix. For example, the cloud component 208 may only be required in the cloud-based mode, not in the MEC-based mode or the RSU-based operation mode. The other components without (C), (R), or (M) suffixes may be used in each of the different modes of operation. Significantly, if one of these modes does not need to be supported, the corresponding (C), (R), or (M) components may be omitted.

Referring more specifically to the vehicle 102, the vehicle 102 may include the OBU 202. The OBU 202 may enables communication with other vehicles 102 and with V2X communication system infrastructure 104. The OBU 202 may accordingly provide the vehicle 102 with enhanced situational awareness and enabling a wide range of V2X applications. The OBU 202 may utilize a wireless transceiver 214 (e.g., a 5G transceiver) to facilitate wireless communication with the RSUs 204 and with network base stations 210. These communications may be performed over various protocols such as via Uu with the network base stations 210 and via PC5 with the RSUs 204, in an example.

The vehicle 102 may also include a human machine interface (HMI) 212. The HMI 212 may be in communication with the OBU 202 over various in-vehicle communications approaches, such as via a controller-area network connection, an Ethernet connection, a Wi-Fi connection etc. The HMI 212 may be configured to provide an interface through which the vehicle 102 occupants may interact with the vehicle 102. The interface may include a touchscreen display, voice commands, and physical controls such as buttons and knobs. The HMI 212 may be configured to receive user input via the various buttons or other controls, as well as provide status information to a driver, such as fuel level information, engine operating temperature information, and current location of the vehicle 102. The HMI 212 may be configured to provide information to various displays within the vehicle 102, such as a center stack touchscreen, a gauge cluster screen, etc. The HMI 212 may accordingly allow the vehicle 102 occupants to access and control various systems such as navigation, entertainment, and climate control.

The OBU 202 may further include additional functionality, such as a V2X stack 216 and a C-V2X Uu client 218. The V2X stack 216 may include software configured to provides the communication protocols and functions required for V2X communication. The V2X stack 216 may include includes components for wireless communication, security, message processing, and network management. The V2X stack 216 may enable communication between the vehicles 102, the infrastructure 104, and other entities in the V2X ecosystem. By using a common V2X stack 216, developers can create interoperable V2X applications that can be used across different vehicles 102 and networks.

The C-V2X Uu client 218 may include hardware and/or software configured to enable communication between the vehicles 102 and the cellular network. In this example, the Uu interface is the radio interface between the C-V2X client and the cellular base station 210. The C-V2X Uu client 218 allows vehicles 102 to access the cellular network and use services such as traffic information, priority services, and location-based services

The vehicle 102 may also include various other sensors 222, such as a global navigation satellite system (GNSS) transceiver configured to provide location services to the vehicle 102, and sensors such as radio detection and ranging (RADAR), light detection and ranging (LIDAR), sound navigation and ranging (SONAR), cameras, etc., that may facilitate sensing of the environment surrounding the vehicle 102.

The OBU 202 may further include a local fusion component 220. In general, data fusion refers to combining multiple sources of data to produce a more accurate, complete, and consistent representation of the information than could be achieved by using a single source alone. In the context of V2X communication, data fusion may help to increase the accuracy and reliability of information exchanged between vehicles 102, infrastructure 104, and other entities. By combining data from different sources, such as the cameras, sensors, and GNSS devices of the vehicle 102, the local fusion component 220 may provide a more complete understanding of the environment, enhancing the effectiveness of applications such as object detection and traffic management.

Turning to the RSU 204, the RSU 204 may also include a wireless transceiver 214, a V2X stack 216 and a C-V2X Uu client 218. The RSU 204 may also include sensors 222 such as cameras, where the sensors 222 of the RSU 204 are configured to detect aspects of the environment surrounding the RSU 204. When configured to be operable in the RSU-based mode, the RSU 204 may further include additional components. These additional components may include a remote fusion component 224, a SDSM generator 226, and a video client 228.

Similar to the local fusion component 220, the remote fusion component 224 may be configured to combine data from different sources, such as the cameras or other sensors 222 of the RSU 204, and messages from the vehicles 102, to provide a more complete understanding of the environment surrounding the RSU 204.

The SDSM generator 226 may be configured to generate SDSM messages based on the information combined by the remote fusion component 224. SDSM messages allow the sharing of information about detected objects among traffic participants. SDSM messages may be broadcast using the wireless transceiver 214 of the RSU 204 and may be received by vehicles 102 or other traffic participants to aid in collective perception with respect to the environment. SDSM messages are discussed in detail in SAE standards document SAE J3224, which is incorporated herein by reference in its entirety.

During the fusion process and the SDSM generation, the source of the information may be lost. This could mean that given a generated SDSM, the recipient may be unable to identify which BSM message (or which detected object from the sensors 222) was used to create this information. BSM messages are discussed in detail in SAE standards document SAE J2735, which is incorporated herein by reference in its entirety.

The SDSM may include an object list of each of the detected objects. To facilitate the identification of the source of the information to a recipient of the SDSM, the SDSM generator 226 may use an enhanced object representation of each object in the SDSM to add additional metadata. The modified SDSM may include, for each enumerated object, a metadata list which describes, for the given object, the type of the data source (BSM, sensor 222, SDSM, etc.), a reference time of the perception information, and an identifier of the previous message. This additional metadata information may increase the size of the SDSM by an acceptable quantity of bytes, while allowing for greater flexibility in a recipient in understanding the source of the data. For instance, this may allow for easier deduplication, or for a sender to filter out data that it sent out itself that is returned in the SDSMs. An example of such an enhanced SDSM is shown in Table 1:

TABLE 1
SDSM with enhanced Metadata to indicate message source

| SDSM | |
|---|---|
| Reference position, time, message count, etc. | |
| Object List | Relative Position, Speed |
| | Perception Time (relative) |
| | Object Type |
| | . . . |

| | |
|---|---|
| Metadata | Sensor Type |
| | Information timestamp |
| | Source Identifier |

The video client 228 may be configured to allow vehicles 102 or other networked devices to have access to video data from the sensors 222. In an example, the sensors 222 may include thermal cameras configured to produce thermal images for detecting the presence of objects or people in low-light or adverse weather conditions. The video client 228 may be used in V2X applications to provide the vehicles 102 and the infrastructure 104 with enhanced situational awareness and object detection capabilities.

When configured to be operable in the cloud-based mode, the cloud component 208 may include various functionality to support the operation of the logical interconnect plane 106. This functionality may include a V2X stack 216, a C-V2X Uu client 218, a remote fusion component 224, a SDSM generator 226, and a video client 228, as discussed above.

Also, in the cloud-based mode or in the RSU-based mode, the MEC 206 may include a V2X stack 216 and a C-V2X message broker 230. The C-V2X message broker 230 is a software component configured to operate as a middleware layer between the C-V2X Uu client 218 and V2X applications. The C-V2X message broker 230 may receive messages from the C-V2X Uu client 218 and route them to the appropriate applications based on the message type and content. The C-V2X message broker 230 also provides security and privacy functions to protect the V2X communications.

When configured to be operable in the MEC-based mode, the MECs 206 may further include various functionality to support the operation of the logical interconnect plane 106, in a position closer to the vehicles 102 than the cloud components 208. This functionality may include a V2X stack 216 for the MEC-based processing that is performed at the MEC 206 instead of via the cloud component 208, as well as a C-V2X Uu client 218, a remote fusion component 224, a SDSM generator 226, and a video client 228, as discussed above.

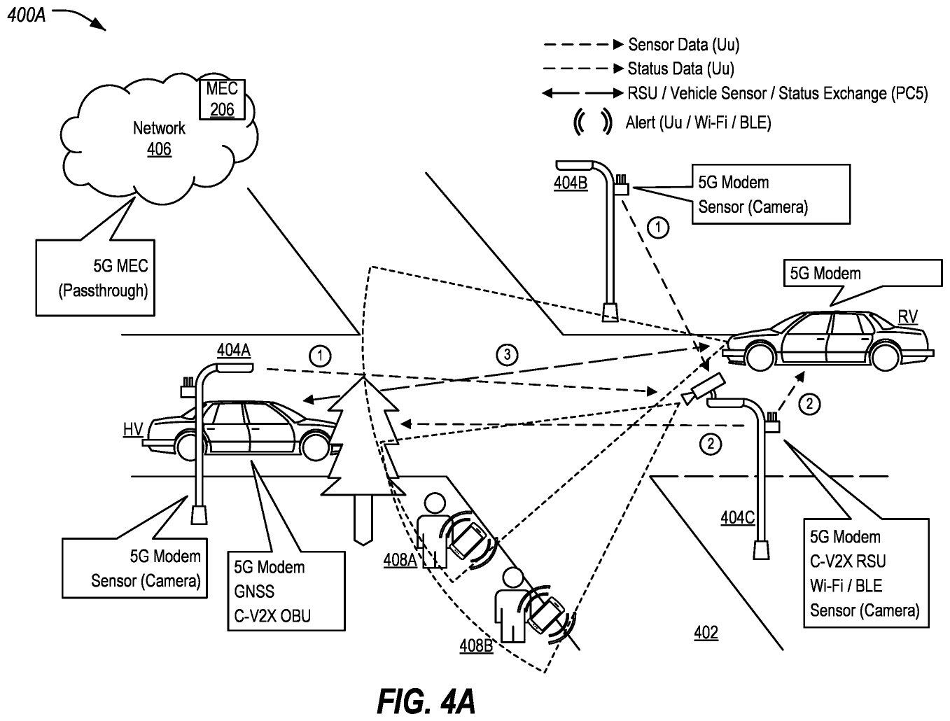

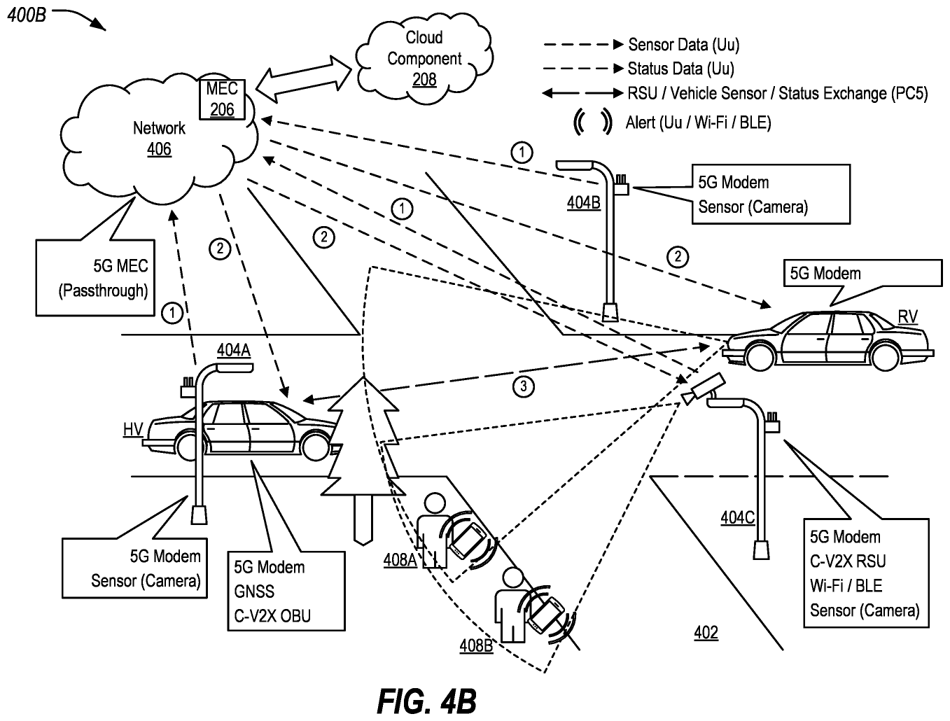

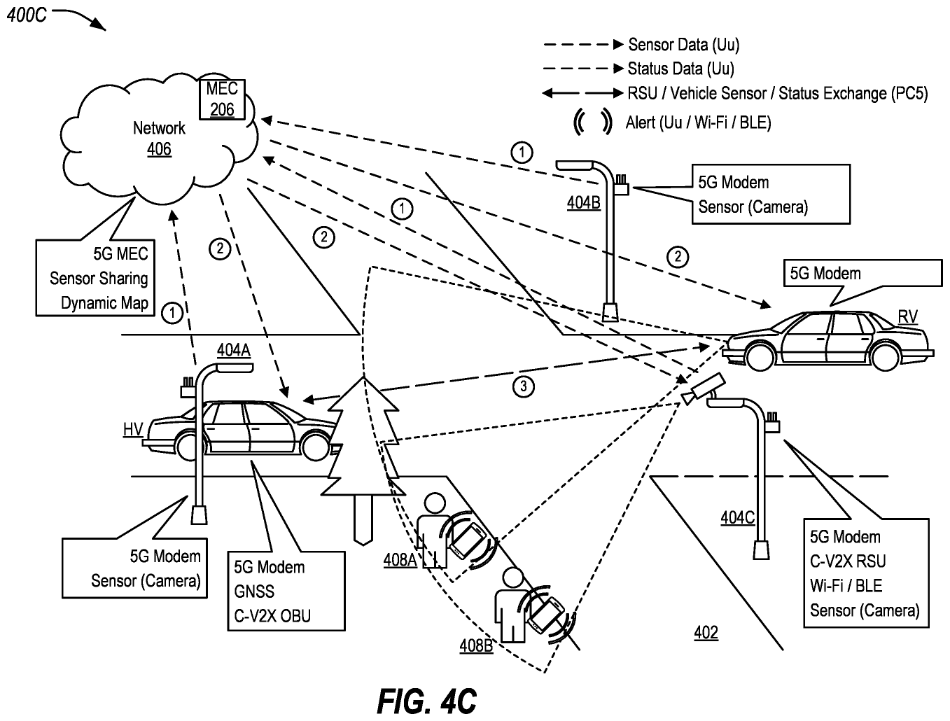

FIG. 4A illustrates an example 400A of far edge data fusion at the roadside using the logical interconnect plane 106 operating in the RSU-based mode of FIG. 3A. The example 400A includes two vehicles 102 traversing a roadway 402. These vehicles 102 include a host vehicle (HV) and a remote vehicle (RV). The example 400A also includes infrastructure 104, including a first infrastructure element 404A having a sensor 222A and a wireless transceiver 214, a second infrastructure element 404B having a sensor 222B and a wireless transceiver 214, and a third infrastructure element 404C having a sensor 222C, a wireless transceiver 214, and an RSU 204. The example 400A also includes a communication network 406 having a MEC 206.

As shown by the dot-dash lines and the identifier (1), the first infrastructure element 404A and the second infrastructure element 404B may broadcast data (e.g., via Uu) from their respective sensors 222A-222B which is received by the third infrastructure element 404C having the RSU 204. As shown by the dashed lines and the identifier (2), the third infrastructure element 404C may broadcast status data (e.g., via Uu) to be received by the HV and the RV. As shown by the long dash - dash lines and the identifier (3), the HV and RV may also communicate sensor or other data via PC5, without utilizing the services of the RSU 204.

The example 400A may also include pedestrians having mobile devices 408. As shown the example 400A includes a first pedestrian having a first mobile device 408A and a second pedestrian having a second mobile device 408B. These users may utilize their mobile devices 408 to receive sensor data and/or other information about the HV, RV or other traffic participants from the RSU 204, e.g., via PC5.

FIG. 4B illustrates an example 400B of baseline data fusion at the cloud component 208 using the logical interconnect plane 106 operating in the cloud-based mode of FIG. 3B. As shown, the 400B similarly includes the HV, the RV, the infrastructure elements 404A-C, the communication network 406 with the MEC 206, and the mobile devices 408A-B. The example 400B further illustrates the cloud component 208 in communication with the MEC 206. As compared to the example 400A, in the example 400B the message processing is performed away from infrastructure 104 on the cloud.

As shown by the dot-dash lines and the identifier (1), at least the first infrastructure element 404A and the second infrastructure element 404B may broadcast data (e.g., via Uu) from their respective sensors 222A-222B which is received by the MEC 206 and passed along to the cloud component 208. As shown by the dashed lines and the identifier (2), the RSU 204 may broadcast status data (e.g., via Uu) received from the cloud component 208 to be provided to the HV, RV, and RSU 204. As shown by the long dash - dash lines and the identifier (3), the HV and RV may also communicate sensor or other data via PC5, without utilizing the services of the OBU 202.

FIG. 4C illustrates an example 400C of MEC-based data fusion at the cloud component 208 using the logical interconnect plane 106 operating in the MEC-based mode of FIG. 3C. As shown, the 400C similarly includes the HV, the RV, the infrastructure elements 404A-C, the communication network 406 with the MEC 206, and the mobile devices 408A-B. As compared to the example 400B, in the example 400C the message processing is performed by the MECs 206, closer to the infrastructure 104 than the processing being performed by the cloud components 208.

As shown by the dot-dash lines and the identifier (1), the first infrastructure element 404A and the second infrastructure element 404B may broadcast data (e.g., via Uu) from their respective sensors 222A-222B which is received by the MEC 206 for edge processing. As shown by the dashed lines and the identifier (2), the RSU 204 may broadcast status data (e.g., via Uu) as processed locally by the MEC 206 to be provided to the HV, RV, and RSU 204. As shown by the long dash - dash lines and the identifier (3), the HV and RV may also communicate sensor or other data via PC5, without utilizing the services of the OBU 202.

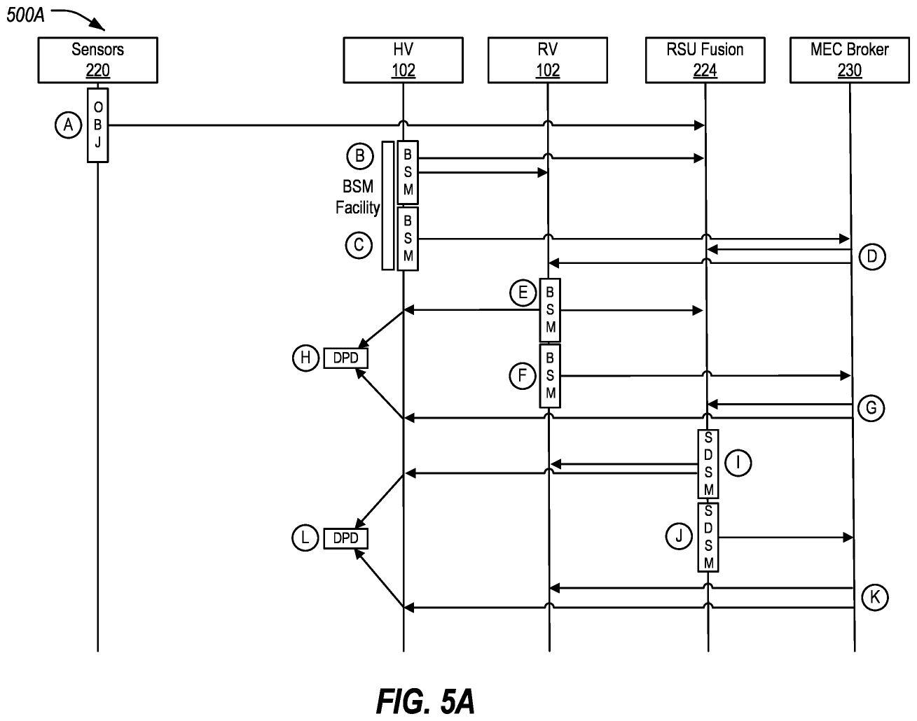

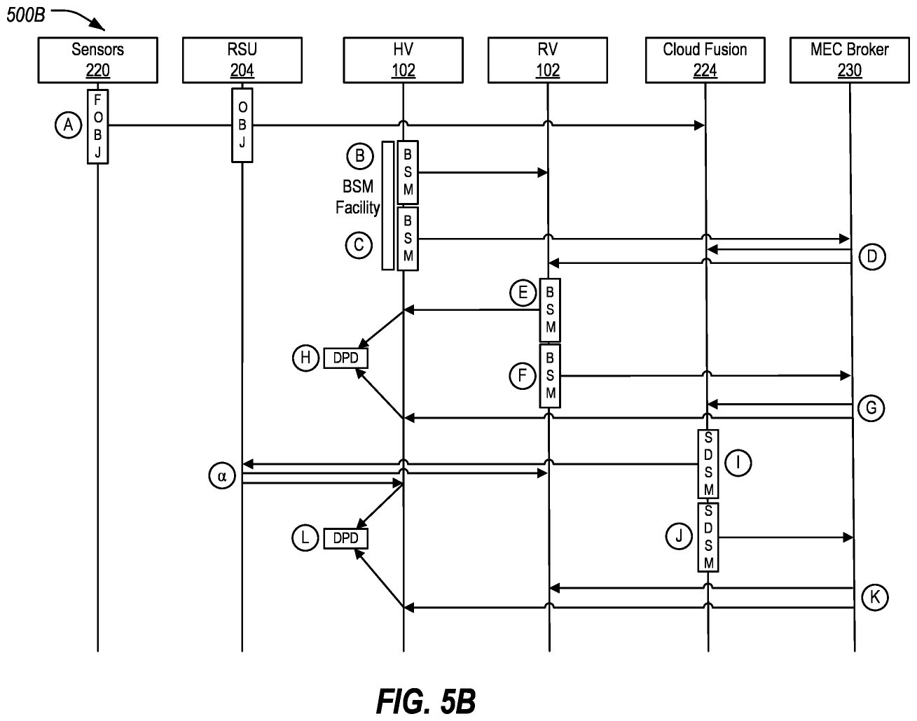

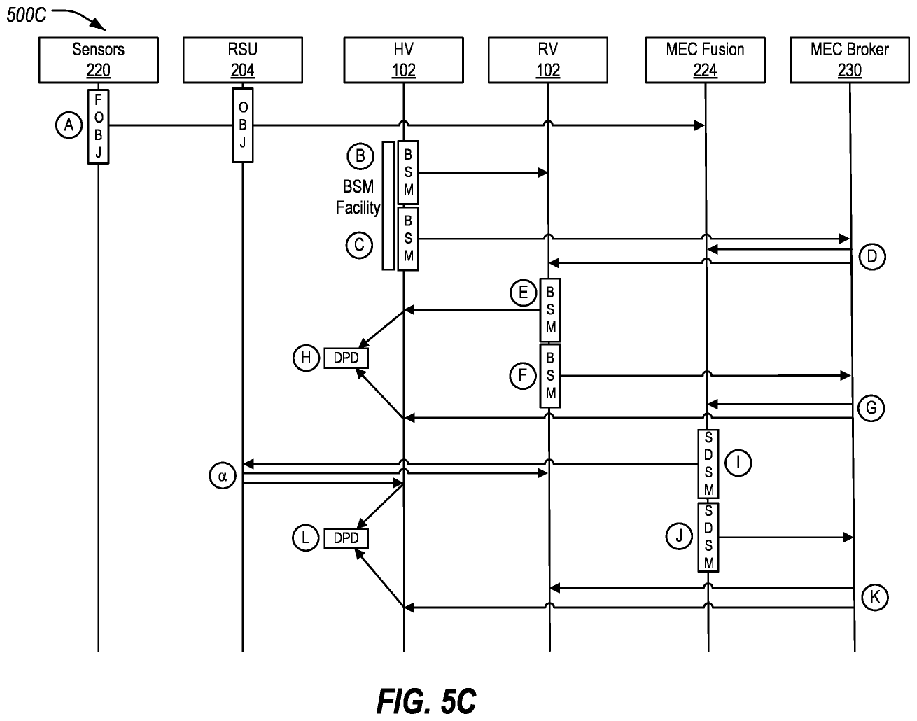

FIG. 5A illustrates an example data flow diagram 500A of the far edge data fusion at the roadside using the logical interconnect plane 106 operating in the RSU-based mode of FIG. 3A. The data flow diagram 500A may accordingly illustrate various aspects as shown graphically in FIG. 4A.

As shown at index (A) of FIG. 5A, the sensors 222 of various infrastructure elements 404 may broadcast sensor data which is received by the RSU 204. For instance, the infrastructure elements 404 may broadcast data (e.g., via Uu) from their respective sensors 222, which are received by the infrastructure element 404 having the RSU 204. In another example, the sensors 222 may be local to the RSU 204 and the sensor data may be locally received by the RSU 204, e.g., via a wired or local wireless connection. The wireless transceiver 214 of the RSU 204 may capture the received data, which may be decoded via the V2X stack 216 and C-V2X Uu client 218 and provided to the remote fusion component 224.

As shown at index (B), the HV may generate BSMs and may broadcast those BSMs via the wireless transceiver 214 of the OBU 202. Vehicles 102 may the broadcast BSMs according to the 3rd generation partnership project (3GPP) release 14/15 C-V2X standard. These messages may include information gleaned from the sensors 222 of the HV as well as other information available to the HV and combined via the local fusion component 220. The BSM messages may be received by the RV and the RSU 204 of the third infrastructure element 404C. The wireless transceiver 214 of the RSU 204 may capture the received data, which may be decoded via the V2X stack 216 and C-V2X Uu client 218 and provided to the remote fusion component 224.

As shown at index (C), the BSMs from the HV may also be received to the C-V2X message broker 230 of the MEC 206. In turn, as shown at index (D), the C-V2X message broker 230 may operate as a passthrough and broadcast the received BSMs. These rebroadcast messages may, in turn, be received by devices in range such as the RSU 204 and/or the RV.

As shown at index (E), the RV may similarly generate BSMs and broadcast BSMs via its wireless transceiver 214 of its OBU 202. These may be received by the HV and/or the RSU 204 as shown. As shown at index (F), these BSMs may also be received by the C-V2X message broker 230 of the MEC 206. As shown at index (G), these messages may be rebroadcast by the MEC 206 to devices in range such as the RSU 204 and/or the HV.

As shown at index (H), the HV may receive BSMs from the RV as well as the same information indirectly through the MEC 206. Accordingly, the HV may implement duplicate packet detection (DPD) to prevent processing of the same information multiple times. The DPD may perform deduplication using various approaches, such as by comparison of message identifier, sequence number, or other fields of the BSMs to identify and remove duplicate packets.

At index (I), the remote fusion component 224 may utilize the SDSM generator 226 to generate SDSM messages. These SDSM messages may be broadcast by the RSU 204 for reception by the HV, RV, and other vehicles 102, e.g., via Uu. As shown at index (J), the SDSM messages may also be received by the MEC 206 and at index (K) may be provided to the C-V2X message broker 230 for passthrough distribution to the HV, RV, and other vehicles 102.

At index (L), the HV may receive SDSMs from the RSU 204 as well as the same information indirectly through the MEC 206. Accordingly, the HV may again utilize DPD to prevent processing of the same information multiple times. The DPD may perform deduplication using various approaches, such as by comparison of message identifier, sequence number, or other fields of the SDSMs to identify and remove duplicate packets.

FIG. 5B illustrates an example data flow diagram 500B of the cloud-based data fusion at the cloud component 208 using the logical interconnect plane 106 operating in the cloud-based mode of FIG. 3B. The data flow diagram 500B may accordingly illustrate various aspects as shown graphically in FIG. 4B. As compared to the data flow diagram 500A, in the data flow diagram 500B the data fusion is performed remotely by the cloud components 208 as opposed to on the far network edge by the RSUs 204.

As shown at index (A), and similar to as shown in FIG. 5A, the RSU 204 may receive sensor data from sensors 222 that are either local to the RSU 204 or within wireless communication range to the RSU 204. The RSU 204 may perform local processing of the sensor data. This may include, for example, preprocessing raw image frames into an image object for transmission. This data may be transmitted by the RSU 204 to the MEC 206, which in turn forwards the information to the cloud component 208 for processing by the remote fusion component 224 of the cloud component 208.

At indexes (B) and (C), the HV may generate and send BSMs, similar to as discussed with respect to the data flow diagram 500A. In turn, as shown at index (D), the C-V2X message broker 230 may operate as a passthrough and broadcast the received BSMs. These rebroadcast messages may, in turn, be received by devices in range such as the cloud component 208 and/or the RV.

As shown at index (E), the RV may similarly generate BSMs and broadcast BSMs via its wireless transceiver 214 of its OBU 202. These may be received by the HV. As shown at index (F), these BSMs may also be received by the C-V2X message broker 230 of the MEC 206. As shown at index (G), these messages may be rebroadcast by the MEC 206 to devices such as the cloud component 208 and/or the HV.

As shown at index (H), the HV may receive BSMs from the RV as well as the same information indirectly through the MEC 206. Accordingly, the HV may implement DPD to prevent processing of the same information multiple times, as noted above.

At index (I), the cloud fusion component 224 may utilize the SDSM generator 226 to generate SDSM messages. These SDSM messages may be sent from the cloud component 208 to the RSU 204. These SDSM messages may be rebroadcast by the RSU 204, as shown at index (a). These rebroadcasts may be received by the HV, RV, and other vehicles 102, e.g., via Uu. As shown at index (J), the SDSM messages may also be received by the MEC 206 and at index (K) may be provided to the C-V2X message broker 230 for passthrough distribution to the HV, RV, and other vehicles 102.

At index (L), the HV may receive SDSMs from the RSU 204 as well as the same information indirectly through the MEC 206. Accordingly, the HV may again utilize DPD to prevent processing of the same information multiple times.

FIG. 5C illustrates an example data flow diagram 500C of the MEC-based data fusion at the MEC 206 using the logical interconnect plane 106 operating in the MEC-based mode of FIG. 3C. The data flow diagram 500C may accordingly illustrate various aspects as shown graphically in FIG. 4C. As compared to the data flow diagram 500B, in the data flow diagram 500C the data fusion is performed on the near network edge by the MEC 206 as opposed to on the cloud components 208 as shown in FIG. 5B, and as opposed to being performed on the RSUs 204 as shown in FIG. 5A. The processing shown in the data flow diagram 500C may be as described about with respect to the data flow diagram 500B, with the difference that the processing discussed as being performed by the cloud component 208 is instead performed by the MEC 206 itself.

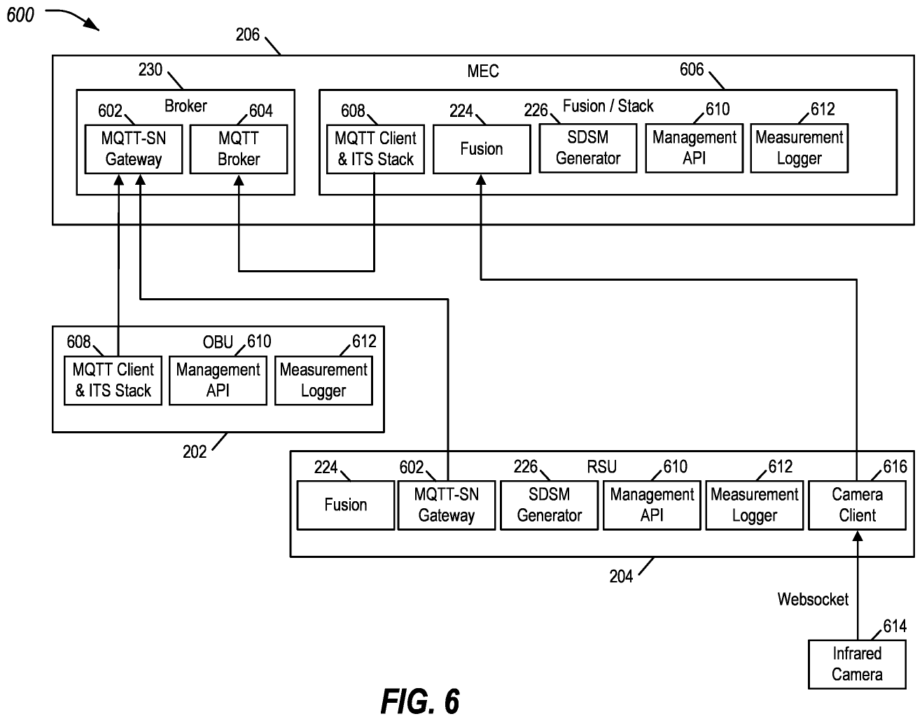

FIG. 6 illustrates an example network diagram 600 of elements of the logical interconnect plane 106 configured for operation in the MEC-based mode. As shown, the MEC 206 includes a C-V2X message broker 230. The C-V2X message broker 230 may include a message queuing telemetry transport (MQTT) for sensor networks (MQTT-SN) gateway 602 and a MQTT broker 604. The MEC 206 may also include fusion/stack components 606. These may include, for example, a MQTT client 608, a remote fusion component 224, a SDSM generator 226, a management application programming interface (API) 610, and a measurement logger 612.

The OBU 202 may include an MQTT client 608 for communication with the MQTT broker 604 of the MEC 206 via the MQTT-SN gateway 602. The OBU 202 may also include a management API 610 and a measurement logger 612.

The RSU 204 may include a MQTT-SN gateway 602 for communication with the MQTT broker 604 of the MEC 206 via the MQTT-SN gateway 602. The RSU 204 may also include a remote fusion component 224, a SDSM generator 226, a management API 610, and a measurement logger 612. The RSU 204 may further include a camera client 616 configured to receive and process sensor data from one or more infrared cameras 614. This data, once processed, may be sent to the remote fusion component 224 of the MEC 206.

As noted herein, the C-V2X message broker 230 may be a software component configured to operate as an intermediary between different systems, allowing them to communicate and exchange data in a decoupled manner. The C-V2X message broker 230 may receive messages from one system and route them to the intended destination system based on predefined rules. This allows systems to interact with each other without the need for direct point-to-point connections, making the overall system more scalable, flexible, and reliable.

As shown in the network diagram 600, the C-V2X message broker 230 may be implemented via MQTT. MQTT offers low latency and high flexibility; thus, it is considered as an option for V2X message distribution. The MQTT-SN gateway 602 is a device or software component configured to bridges between MQTT-SN and other networks, allowing devices to connect to and send data to the MQTT broker 604.

The message broker 230 may be built on MQTTv5 and MQTT-SN protocols. The MQTTv5 is a TCP-based communication protocol. MQTTv5 may directly connect to the MQTT broker 604. The MQTT-SN, which is a user datagram protocol (UDP) based protocol, may be used on the radio link side to prevent unnecessary delays caused by packet drops, which triggers transmission control protocol (TCP) retransmissions. The MQTT-SN protocol requires the MQTT-SN gateway 602 to connect to the regular MQTT broker 604. The MQTT-gateway may maintains regular MQTTv3.1.1 connection to the MQTT broker 604. The connection to the message broker 230 may either be managed by one joint connection for each MQTT-SN client or separate connections for each client.

The MQTT broker 604 enables devices and applications to publish and subscribe to messages over the Internet or other networks in a lightweight and efficient way. The MQTT broker 604 may be configured to receive messages from the MQTT clients 608 and forward them to other clients that have subscribed to the relevant topics.

The MQTT client 608 is a software component or device that uses the MQTT protocol to communicate with the MQTT broker 604. The MQTT client 608 may publish messages to the MQTT broker 604 and/or subscribe to specific topics to receive messages from the MQTT broker 604. The MQTT clients 608 of the RSUs 204 and OBUs 202 may be configured to communicate with the MQTT brokers 604 via UDP on port 1883. Port 1883 is a commonly used port number for MQTT brokers 604 and may be a default port for the MQTT protocol when used with UDP. Internal communication between the MQTT client 608 of the MEC 206 and the MQTT broker 604 may be performed using TCP as opposed to UDP, but the same port 1883 may also be used. Connectionless protocols such as UDP may be advantages outside of internal communications of the MEC 206 to reduce connection and error checking overhead across wireless channels.

The MQTT QOS used may be that a message is delivered at most once, consistent with the message broadcast behavior of BSM and SDSM messages. During the communication, separate MQTT topics may be used for BSMs and SDSMs. A no local option may be used to allow a device to prevent receiving its own messages.

The management API 610 refers to a set of programming instructions and standards for accessing a web-based software application or web tool. The management API 610 may allow administrative users to programmatically access and manage the functionality of the MECs 206, OBUs 202, and/or RSUs 204.

The measurement logger 612 refers to a hardware or software component that records and stores measurements from sensors 222 or other measurement devices over time. The measurement logger 612 may allow for monitoring, and quality control to track and analyze changes in the operation of the logical interconnect plane 106.

The OBU 202 may utilize a PC5 modem and the V2X stack 216 containing both MQTT and the PC5 adaptations. The V2X stack 216 in the OBU 202 may support both MQTT-SN and MQTTv5 client variants.

The RSU 204 may utilize one or more infrared cameras 614 and a 5G modem. The infrared camera 614 is a type of imaging device that captures images and video using infrared radiation. The infrared cameras 614 may be used to visualize temperature differences in objects, detect hot spots, and identify thermal patterns. The camera client 616 refers to a device or software application that is used to access and process data from infrared cameras 614. Infrared cameras 614 capture thermal images that may be used to detect the presence of objects or people in low-light or adverse weather conditions. The camera client 616 may be used in V2X applications to provide the vehicles 102 and the infrastructure 104 with enhanced situational awareness and object detection capabilities. Communications between the camera client 616 of the RSU 204 and the remote fusion component 224 of the MEC 206 may be performed via UDP on various ports, which may be assigned as desired.

The infrared cameras 614 may perform object detection algorithms to track perceived objects such as various types of vehicles 102, and other road users such as pedestrians, bicyclists and motorcyclists. On the RSU 204, a software component may transform the object information to a proprietary message over standard UDP packet format and may forward this information to the fusion. The location of the fusion may be configurable in accordance with the deployment scheme.

The RSU 204 may also contain the perception fusion software. This component may collect the perceived data from the cameras and the BSMs from the communication channel and fuse this information to provide clients with FODM. The RSU 204 sent the proper FODM packets using the built in PC5 connectivity. The RSU 204 may utilize management API 610 to facilitate the measurements. The RSU 204 and the infrared cameras 614 may be connected to the 5G modem via Ethernet so that the perceived data may be forwarded to other fusion solutions.

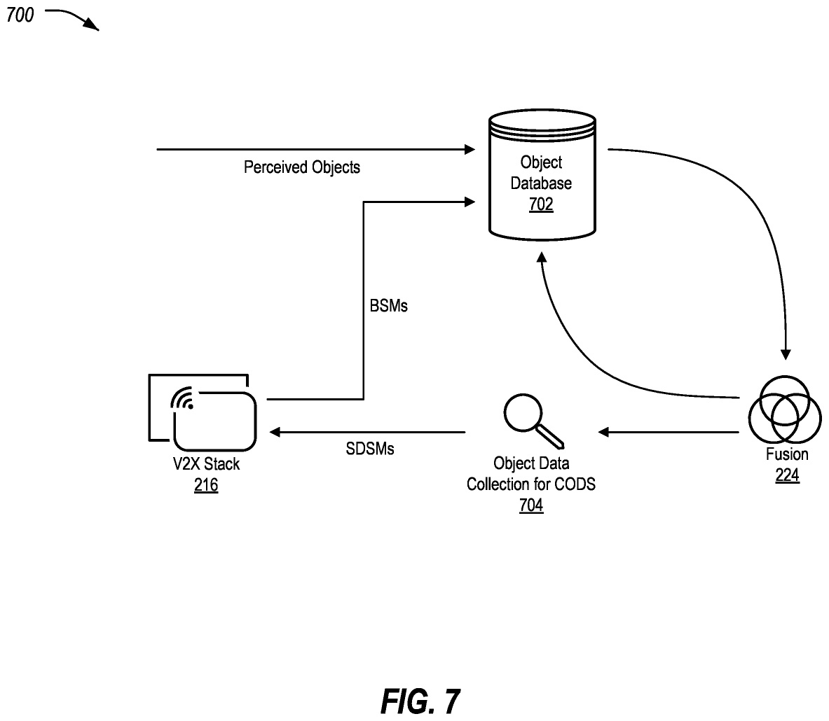

FIG. 7 illustrates details of the operation of a centralized fusion 700 to provide FODM to client devices. The centralized fusion 700 is configured to provide FODM to client devices. This centralized fusion 700 approach may utilize various components. The V2X stack 216 may utilize a MQTTv5 and MQTT-SN based stack implementation as noted above. The V2X stack 216 was used to collect BSMs from the communication network 406 and forward this information to the fusion component 224. The perception information from the camera client 616 or other sensors 222 may also be forwarded to the fusion component 224.

The fusion component 224 may be responsible for creating a consolidated object database 702 from the BSMs and the perception information. The consolidated object database 702 may include an overall representation of detected objects, including representation of each unique, deduplicated object specified by the vehicle connected messages and by the perception information. In an example, the consolidated object database 702 may include a plurality of data records or elements, where each data record is a row including fields about a specific object. These fields of information may include aspects such as location of the object, message source of the object, time the object was identified, etc.

This consolidated information may be passed to the V2X stack 216, where it may be assembled into objects to create SDSMs (e.g., via an SDSM generator 226), where the SDSMs may be sent to subscribed MQTT clients 608.

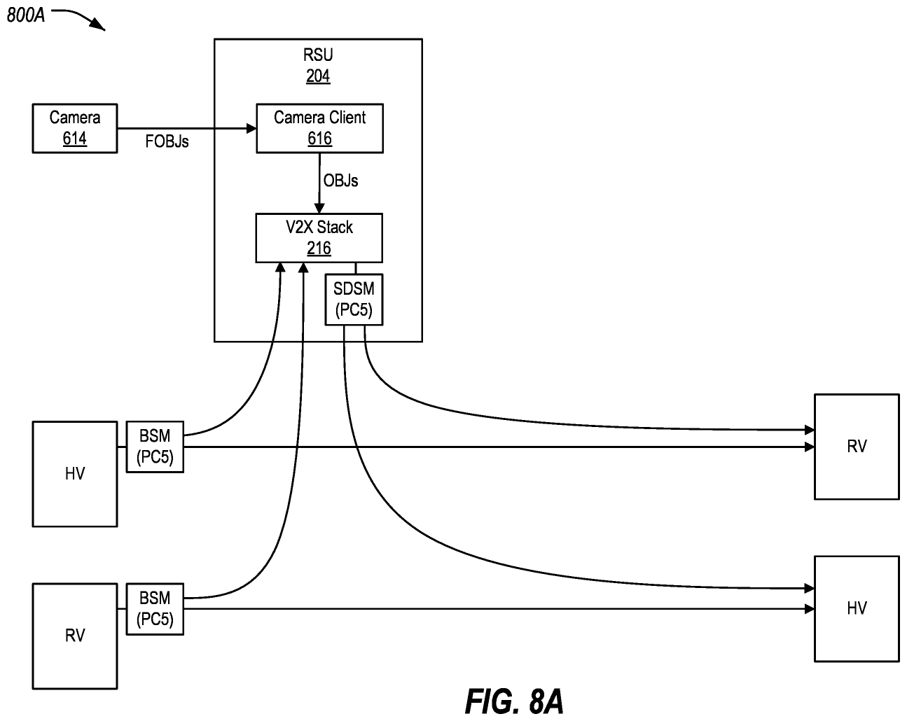

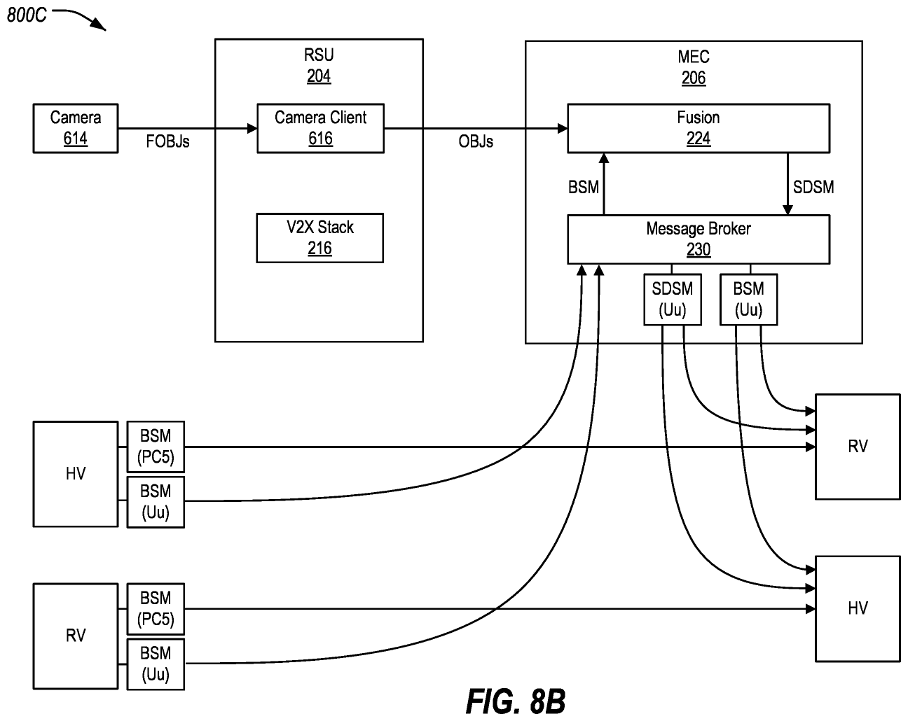

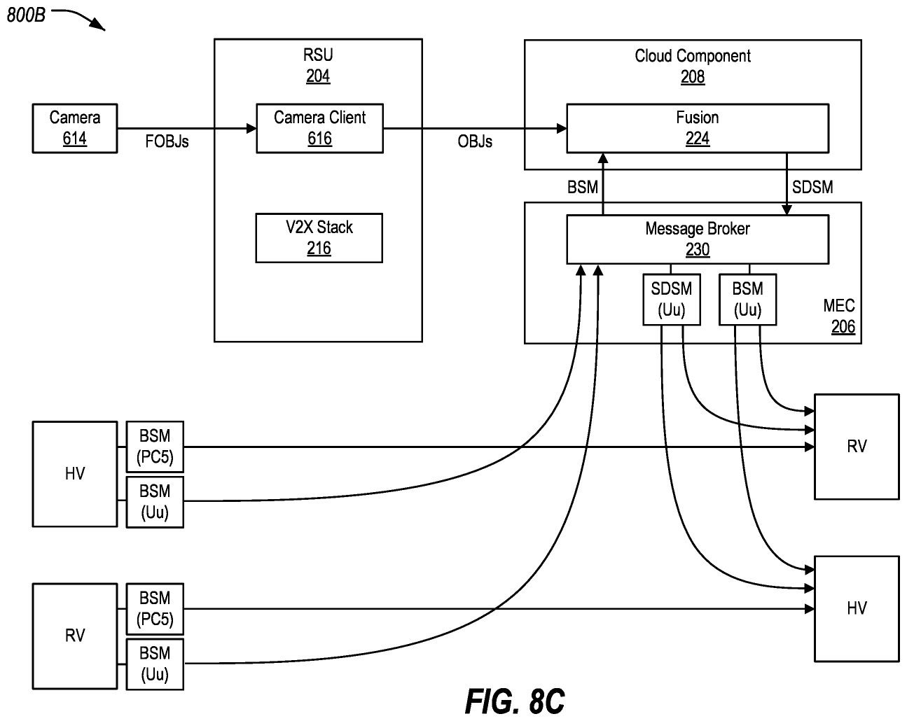

FIG. 8A illustrates an example implementation 800A of the centralized fusion 700 in an RSU-based mode. In such an RSU-based deployment scheme, the centralized fusion 700 relies purely on PC5 communication. In this example, there is no 5G Uu communication enabled. The OBU 202 of the HV and the OBU 202 of the RV may generate BSMs based on their navigation data and may send this information to the RSU 204. The infrared cameras 614 may provide sensor information to the fusion component 224 in the RSU 204. The fusion component 224 may also process the BSMs from the V2X stack 216 of the RSU 204. The fusion component 224 may collect the BSMs and perception information to create the consolidated object database 702. The objects may be sent to the V2X stack 216, which assembles SDSMs using the SDSM generator 226 and transmits the packets through the PC5 interface. Responsive to the OBUs 202 receiving this information, the vehicles 102 may use it to provide various features, such as object detection and contextual awareness services.

FIG. 8B illustrates an example implementation 800B of the centralized fusion 700 in a MEC-based mode. In the MEC-based deployment scheme, the OBUs 202 may use their MQTT interface to send BSMs to the MQTT broker 604 which forwards the messages since the OBUs 202 are subscribed the same topic. The MQTT broker 604 may be deployed in the MEC 206. The MEC 206 may contains another virtual machine (VM) as well which runs the centralized fusion 700 unit. The V2X stack 216 of the centralized fusion 700 unit subscribes for the BSMs and forwards this information to the fusion component 224. The RSU 204 may utilize the perception data conversion scripts to forward the perception information from the infrared cameras 614 to the fusion component 224 of the MEC 206. The fusion component 224 of the MEC 206 may collect the BSMs and the perception data and may send the data to the V2X stack 216 in the MEC 206. The V2X stack 216 may assemble the SDSMs using the SDSM generator 226 and publish the messages to the MQTT broker 604. As the OBUs 202 are subscribed to the SDSMs, the MQTT broker 604 may forwards the messages to the subscribed OBUs 202.

FIG. 8C illustrates an example implementation 800C of the centralized fusion 700 in a cloud-based mode. In the cloud-based deployment scheme, which is similar to the MEC-based deployment scheme, the deployment and the configuration of the OBUs 202 and the MQTT broker 604 was identical to the MEC 206 scenario. However, the centralized fusion 700 unit may be deployed in a VM of the cloud component 208 instead of on a VM of the MEC 206. The RSU 204 also forwards the perception information to the cloud instead of the MEC 206. The message flow was similar to the MEC 206 use case, the OBUs 202 sends the BSMs to the MQTT broker 604, the MQTT broker 604 forwards the BSMs to the cloud V2X stack 216 where the fusion component 224 creates the consolidated object database 702, which is sent back to the OBUs 202 via the MQTT broker 604.

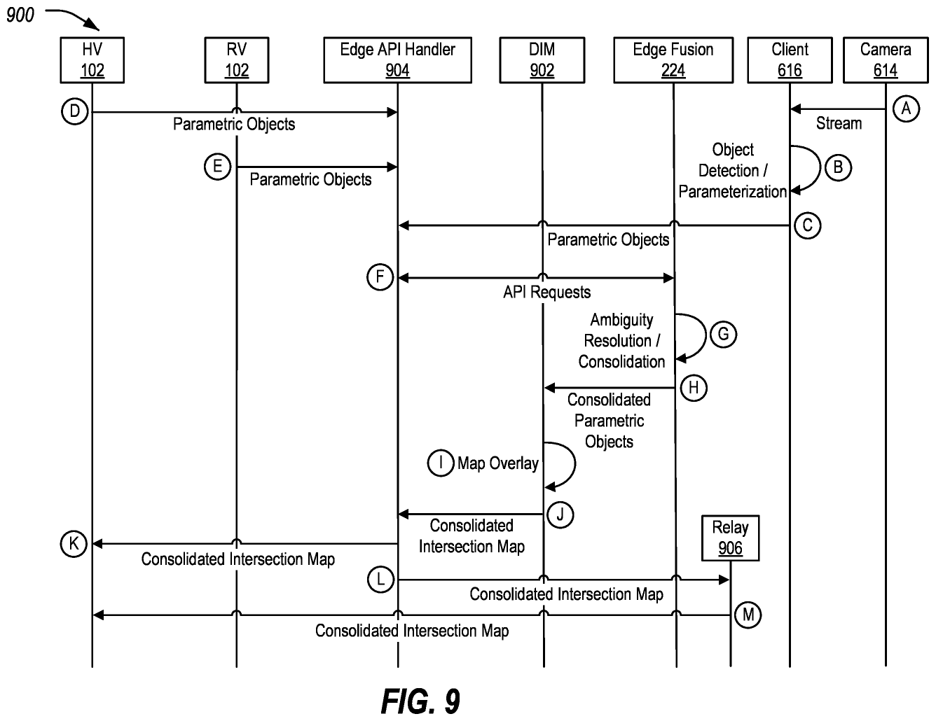

FIG. 9 illustrates an example data flow diagram 900 for use of the centralized fusion 700 of the logical interconnect plane 106 in the edge-based mode for object notification. In an example, the data flow diagram 900 may be performed by the edge-based architecture discussed herein, such as that shown in FIG. 3C and/or FIG. 6. As shown, the data flow diagram 900 includes elements at the vehicle 102 level, such as a HV and an RV. The data flow diagram 900 also includes elements at the edge level, such as an edge fusion component 224 and a dynamic intersection map (DIM) component 902. The edge components may interface with the vehicles 102 using an edge API handler 904. The data flow diagram 900 may also include roadside infrastructure 104, such as an infrared camera 614 or other sensors 222 and a camera client 616 or other sensor data processing component.

At index (A), the infrared camera 614 (or other sensors 222) stream image data to the camera client 616 (or other sensor data processing component). This streaming may be done locally and/or natively with respect to the sensing and processing components.

At index (B), object detection and parameterization is performed by the camera client 616 (or other sensor data processing component). This may be done to identify vehicles 102, pedestrians, obstructions, or other elements in the received data. Various techniques may be used to perform the detection, including machine learning approaches such as image segmentation and object classification. The identified objects may be parameterized into messages, such as into BSM messages or into SDSM messages, where the messages are sent from the infrastructure 104 to the edge API handler 904 at index (C).

At index (D), the HV may also send parametric objects to the edge API handler 904. These may be specified in BSMs, as noted above. At index (E), the RV may also send parametric objects to the edge API handler 904. These may also be specified in BSMs, as noted above.

Having received parametric objects from various sources, at index (E) the edge API handler 904 may handle API requests between the MEC 206 edge components and the edge fusion component 224 to allow the fusion component 224 to perform fusion of the received parametric object information. At index (G), the fusion component 224 performs ambiguity resolution and/or consolidation. The ambiguity resolution may include aspects such as least-squares ambiguity decorrelation adjustment. The consolidation may include combining the resolved objects into an overall representation of detected objects in the consolidated object database 702.

At index (H), these consolidated parametric objects are sent to the DIM component 902. At index (I), the DIM component 902 overlays the consolidated parametric objects over map data to form a consolidated intersection map. At index (J), the consolidated intersection map is sent to the edge API handler 904 for distribution to the vehicles 102. This map may accordingly be received by the vehicles 102, such as the HV and RV, to perform cooperative maneuvers through the intersection using a common data model of the detected objects.

At index (L), the consolidated intersection map may also be provided by the edge API handler 904 to a relay 906 (such as another MEC 206 or RSU 204), for distribution to the same or other vehicles 102 at index (M).

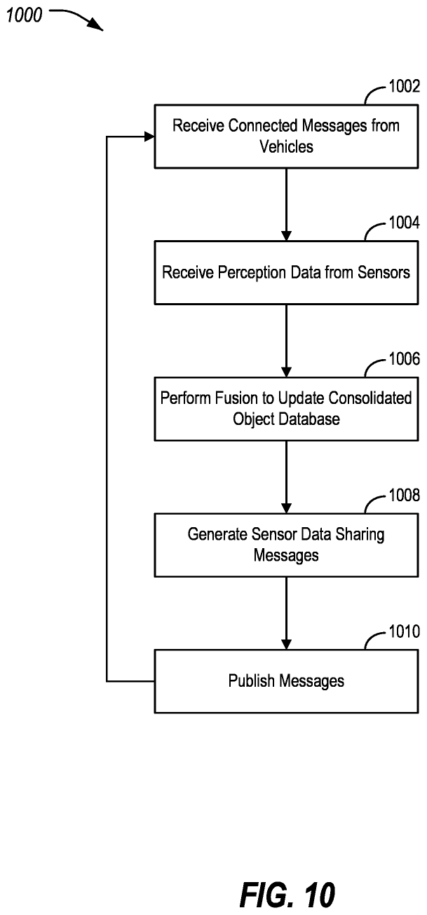

FIG. 10 illustrates an example process 1000 for implementing centralized fusion 700 via the logical interconnect plane 106 for seamless communication. In an example, the process 1000 may be performed by the components discussed in detail herein, in RSU-based, MEC-based, or cloud-based configurations.

At operation 1002, the logical interconnect plane 106 receives connected messages from vehicles 102. In an example, the logical interconnect plane 106 may receive connected messages from OBUs 202 of the vehicles 102, where the connected messages specify vehicle information including locations of the vehicles 102. The connected messages may include BSMs, in an example. The connected messages may be received over various protocols, such as over Uu and/or over PC5. In the RSU-based deployment scheme, the OBU 202 of the HV and the OBU 202 of the RV may generate BSMs based on their navigation data and may send this information to the RSU 204. In the MEC-based deployment scheme or the cloud-based deployment scheme, the OBUs 202 may use their MQTT interface to send BSMs to the MQTT broker 604.

At operation 1004, the logical interconnect plane 106 receives perception data from sensors 222. In the RSU-based deployment scheme, the infrared cameras 614 may provide sensor information to the fusion component 224 in the RSU 204. In the MEC-based deployment scheme or the cloud-based deployment scheme, the MQTT broker 604 MEC 206 subscribes for the BSMs and forwards this information to the fusion component 224.

At operation 1006, the logical interconnect plane 106 performs fusion to update the consolidated object database 702 based on the connected messages and the perception data. The fusion component 224 may be used to combine the vehicle locations and the object locations to form and/or update the consolidated object database 702 including elements specifying each of the vehicles 102 and the perception objects. The fusion component 224 may also be configured to perform deduplication of the data elements of the consolidated object database 702 using information such as message identifier and/or reference time of perception. In the RSU-based deployment scheme, the fusion component 224 of the RSU 204 processes the BSMs from the V2X stack 216 and the perception information to create the consolidated object database 702. In the MEC-based deployment scheme the fusion component 224 of the MEC 206 collect the BSMs and the perception data to create the consolidated object database 702. In the cloud-based deployment scheme MEC 206 sends the BSMs and the perception data to the cloud component 208, which uses its fusion component 224 to create the consolidated object database 702.

At operation 1008, the logical interconnect plane 106 generates SDSMs for the elements of the consolidated object database 702. In an example, the SDSM generator 226 may generate SDSMs describing each of the elements of the consolidated object database 702, thereby informing a recipient of the locations of each of the vehicles 102 and detected objects. The SDSM generator 226 may be further configured to add metadata to the SDSMs including, for each data element, a type of data source for the data element and a reference time of perception of the data element. In the RSU-based deployment scheme, the SDSM generator 226 of the RSU 204 generates the SDSM messages for the elements of the consolidated object database 702. In the MEC-based deployment scheme, the SDSM generator 226 of the MEC 206 generates the SDSM messages for the elements of the consolidated object database 702. In the cloud-based deployment scheme, the SDSM generator 226 of the cloud component 208 generates the SDSM messages for the elements of the consolidated object database 702, where the SDSM messages are then sent back to the MEC 206 for distribution.

At operation 1010, the logical interconnect plane 106 publishes the SDSMs using the MQTT broker 604. In the RSU-based deployment scheme, the V2X stack 216 may transmit the SDSM packets through the PC5 interface to the OBUs 202 of the vehicles 102. In the MEC-based deployment scheme or the cloud-based deployment scheme, the V2X stack 216 of the MEC 206 may publish the SDSMs to the MQTT broker 604. As the OBUs 202 are subscribed to the SDSMs, the MQTT broker 604 may forwards the messages to the subscribed OBUs 202. Responsive to the OBUs 202 receiving this information, the vehicles 102 may use the elements of the consolidated object database 702 to provide various features, such as object detection and contextual awareness services. After operation 1010, the process returns to operation 1002.

While an exemplary modularization of components is described herein, it should be noted that functionality of the infrastructure 104, sensors 222, RSUs 204, MECs 206, cloud components 208, and other devices of the logical interconnect plane 106 may be incorporated into more, fewer or different arranged components. For instance, while many of the components are described separately, aspects of these components may be implemented separately or in combination by one or more controllers in hardware and/or a combination of software and hardware.

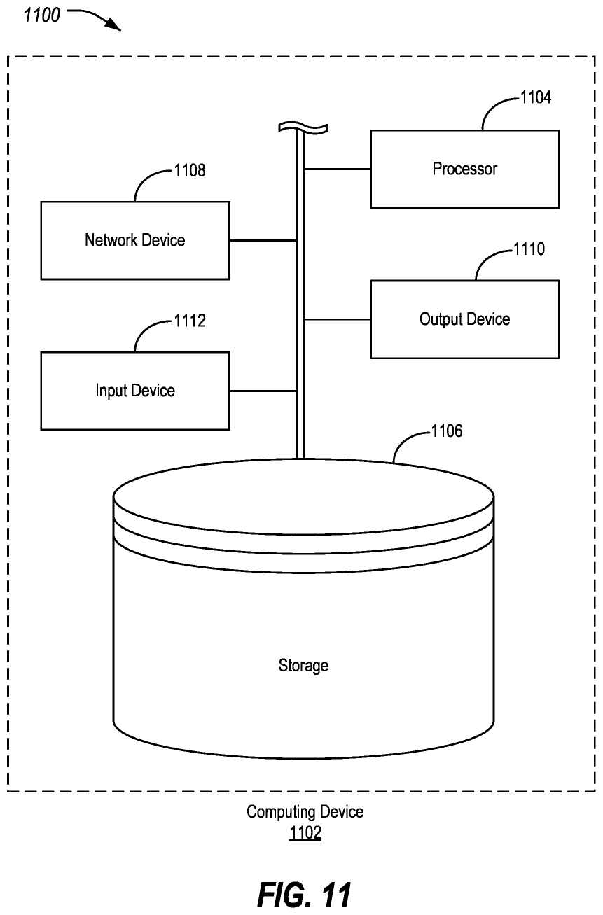

FIG. 11 illustrates an example 1100 of a computing device 1102 for use in interoperability of vehicles 102 having different communications technologies. Referring to FIG. 11, and with reference to FIGS. 1-8, the OBUs 202, RSUs 204, MECs 206, cloud components 208, base stations 210, HMI 212, wireless transceivers 214, etc., may be examples of such computing devices 1102. As shown, the computing device 1102 may include a processor 1104 that is operatively connected to a storage 1106, a network device 1108, an output device 1110, and an input device 1112. It should be noted that this is merely an example, and computing devices 1102 with more, fewer, or different components may be used.

The processor 1104 may include one or more integrated circuits that implement the functionality of a central processing unit (CPU) and/or graphics processing unit (GPU). In some examples, the processors 1104 are a system on a chip (SoC) that integrates the functionality of the CPU and GPU. The SoC may optionally include other components such as, for example, the storage 1106 and the network device 1108 into a single integrated device. In other examples, the CPU and GPU are connected to each other via a peripheral connection device such as peripheral component interconnect (PCI) express or another suitable peripheral data connection. In one example, the CPU is a commercially available central processing device that implements an instruction set such as one of the x86, ARM, Power, or microprocessor without interlocked pipeline stages (MIPS) instruction set families.

Regardless of the specifics, during operation the processor 1104 executes stored program instructions that are retrieved from the storage 1106. The stored program instructions, accordingly, include software that controls the operation of the processors 1104 to perform the operations described herein. The storage 1106 may include both non-volatile memory and volatile memory devices. The non-volatile memory includes solid-state memories, such as not AND (NAND) flash memory, magnetic and optical storage media, or any other suitable data storage device that retains data when the system is deactivated or loses electrical power. The volatile memory includes static and dynamic random-access memory (RAM) that stores program instructions and data during operation of the system 100.

The GPU may include hardware and software for display of at least two-dimensional (2D) and optionally three-dimensional (3D) graphics to the output device 1110. The output device 1110 may include a graphical or visual display device, such as an electronic display screen, projector, printer, or any other suitable device that reproduces a graphical display. As another example, the output device 1110 may include an audio device, such as a loudspeaker or headphone. As yet a further example, the output device 1110 may include a tactile device, such as a mechanically raisable device that may, in an example, be configured to display braille or another physical output that may be touched to provide information to a user.

The input device 1112 may include any of various devices that enable the computing device 1102 to receive control input from users. Examples of suitable input devices that receive human interface inputs may include keyboards, mice, trackballs, touchscreens, voice input devices, graphics tablets, and the like.

The network devices 1108 may each include any of various devices that enable the devices discussed herein to send and/or receive data from external devices over networks. Examples of suitable network devices 1108 include an Ethernet interface, a Wi-Fi transceiver, a Li-Fi transceiver, a cellular transceiver, or a BLUETOOTH or BLUETOOTH low energy (BLE) transceiver, or other network adapter or peripheral interconnection device that receives data from another computer or external data storage device, which can be useful for receiving large sets of data in an efficient manner.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, life cycle, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A federated object data mechanism (FODM) for multi-radio access technology (RAT) vehicle-to-everything (V2X) communication, comprising:
one or more hardware components, configured to
receive connected messages from vehicles, the connected messages specifying vehicle information including vehicle locations of the vehicles;
receive perception objects from sensors of roadside infrastructure, the perception objects specifying object locations as perceived by the sensors;
utilize a fusion component to combine the vehicle locations and the object locations to form a consolidated object database including data elements specifying each of the vehicles and the perception objects;
utilize a sensor data sharing message (SDSM) generator to generate SDSMs describing each of the data elements of the consolidated object database; and
utilize a message broker to publish the SDSMs to topics for retrieval by the vehicles.

2. The FODM of claim 1, wherein the one or more hardware components include a multi-access edge computing (MEC) device configured to implement the fusion component, the SDSM generator, and the message broker.

3. The FODM of claim 1, wherein the one or more hardware components include a cloud component configured to implement the fusion component, in communication with a MEC device configured to implement the SDSM generator and the message broker.

4. The FODM of claim 1, wherein the one or more hardware components include a road side unit (RSU) configured to receive raw sensor data from a sensor, and utilize a corresponding sensor client to generate the perception objects from the raw sensor data.

5. The FODM of claim 1, wherein a first vehicle of the vehicles supports a first RAT, a second vehicle of the vehicles supports a second RAT but not the first RAT, and the first and second vehicles are configured to interoperate using a logical interconnect plane of the federated object data mechanism (FODM).

6. The FODM of claim 1, wherein the SDSM generator is configured to add metadata to the SDSMs including, for each data element, a type of data source for the data element and a reference time of perception of the data element.

7. The FODM of claim 1, wherein the fusion component is configured to perform deduplication of the data elements of the consolidated object database by message identifier, geolocation, and/or reference time of perception.

8. A method for providing a federated object data mechanism (FODM) for multi-radio access technology (RAT) vehicle-to-everything (V2X) communication using one or more hardware components, comprising:
receiving connected messages from vehicles, the connected messages specifying vehicle information including vehicle locations of the vehicles;
receiving perception objects from sensors of roadside infrastructure, the perception objects specifying object locations as perceived by the sensors;
utilizing a fusion component to combine the vehicle locations and the object locations to form a consolidated object database including data elements specifying each of the vehicles and the perception objects;
utilizing a sensor data sharing message (SDSM) generator to generate SDSMs describing each of the data elements of the consolidated object database; and
utilizing a message broker to publish the SDSMs to topics for retrieval by the vehicles.

9. The method of claim 8, wherein the one or more hardware components include a multi-access edge computing (MEC) device configured to implement the fusion component, the SDSM generator, and the message broker.

10. The method of claim 8, wherein the one or more hardware components include a cloud component configured to implement the fusion component, in communication with a MEC device configured to implement the SDSM generator and the message broker.

11. The method of claim 8, wherein the one or more hardware components include a road side unit (RSU) configured to receive raw sensor data from a sensor, and utilize a corresponding sensor client to generate the perception objects from the raw sensor data.

12. The method of claim 8, wherein a first vehicle of the vehicles supports a first RAT, a second vehicle of the vehicles supports a second RAT but not the first RAT, and the first and second vehicles are configured to interoperate using a logical interconnect plane of the federated object data mechanism (FODM).

13. The method of claim 8, further comprising adding metadata, by the SDSM generator, to the SDSMs including, for each data element, a type of data source for the data element and a reference time of perception of the data element.

14. The method of claim 8, further comprising performing, by the fusion component, deduplication of the data elements of the consolidated object database by message identifier, geolocation, and/or reference time of perception.

15. A non-transitory computer-readable medium comprising instructions for providing a federated object data mechanism (FODM) for multi-radio access technology (RAT) vehicle-to-everything (V2X) communication that, when executed by one or more hardware components, cause the one or more hardware components to perform operations including to:
receive connected messages from vehicles, the connected messages specifying vehicle information including vehicle locations of the vehicles;
receive perception objects from sensors of roadside infrastructure, the perception objects specifying object locations as perceived by the sensors;
utilize a fusion component to combine the vehicle locations and the object locations to form a consolidated object database including data elements specifying each of the vehicles and the perception objects;
utilize a sensor data sharing message (SDSM) generator to generate SDSMs describing each of the data elements of the consolidated object database; and
utilize a message broker to publish the SDSMs to topics for retrieval by the vehicles.

16. The medium of claim 15, wherein the one or more hardware components include a multi-access edge computing (MEC) device configured to implement the fusion component, the SDSM generator, and the message broker.

17. The medium of claim 15, wherein the one or more hardware components include a cloud component configured to implement the fusion component, in communication with a MEC device configured to implement the SDSM generator and the message broker.

18. The medium of claim 15, wherein the one or more hardware components include a road side unit (RSU) configured to receive raw sensor data from a sensor, and utilize a corresponding sensor client to generate the perception objects from the raw sensor data.

19. The medium of claim 15, further comprising instructions that, when executed by one or more hardware components, cause the one or more hardware components to perform operations including to add metadata, by the SDSM generator, to the SDSMs including, for each data element, a type of data source for the data element and a reference time of perception of the data element.

20. The medium of claim 15, further comprising instructions that, when executed by one or more hardware components, cause the one or more hardware components to perform operations including to perform, by the fusion component, deduplication of the data elements of the consolidated object database by message identifier, geolocation, and/or reference time of perception.
